(19) United States
(12) Patent Application Publication
(10) Pub. No.: US 2010/0070433 A1
(43) Pub. Date: Mar. 18, 2010

(54) INVESTMENT ALLOCATION SYSTEM FOR MANAGING INVESTMENT RETURN AND RISK AND METHOD THEREOF

(75) Inventor: JENHER JENG, Linnei Township (TW)

Correspondence Address: Wang Law Firm, Inc., 4989 Peachtree Parkway,, Suite 200, Norcross, GA, 30092, US

(73) Assignee: SIFEON KNOWLEDGE-TECHNOLOGY, TAICHUNG CITY (TW)

(21) Appl. No.: 12/623,562

(22) Filed: Nov. 23, 2009

Related U.S. Application Data
(63) Continuation-in-part of application No. 11/806,096, filed on May 30, 2007.

(51) Int. Cl. G06Q 40/00

(52) U.S. Cl. 705/36 R

(57) ABSTRACT

The present invention discloses an investment allocation system for managing investment return and risk and method thereof. The investment allocation system comprises a storage unit, a MDD computation unit, an operation unit, and an allocation process unit. The storage unit stores a threshold, first data sets comprising values of potential investments, and second data sets comprising values of benchmark assets. The MDD computation unit transforms the data sets into MDD sequences. The threshold is assigned to the first MDD sequence in order to obtain a corresponding kth-quantile thereof. Further, an operation unit inserts an object according to the kth-quantile into the second MDD sequence. The operation unit further divides the number of the second list of objects having smaller values than the object by the number of the whole second list of objects to obtain a consistency index. Also, an allocation process unit allocates assets by processing the consistency indexes.

### RELATED APPLICATION

This application is a Continuation-In-Part of U.S. patent application Ser. No. 11/806,096, Investment Allocation System, Analysis Module And Method Thereof, filed on May 30, 2007; the entire content of which is incorporated herein by this reference.

### FIELD OF THE INVENTION

The present invention is related to an investment allocation system for managing investment return and risk and method thereof. Particularly, the present invention provides a consistency index to evaluate the stability of growth of potential investments.

### BACKGROUND OF THE INVENTION

Nowadays, people are making a variety of investment, so there are all kinds of products and services available on the market about analyzing investment combination for expected profit returns and reduced risks, such as Monte Carlo simulation and value-at-risk (VaR) model mentioned in the U.S. Pat. No. 7,599,872 B2.

Admittedly, those approaches have their advantages. For example, Monte Carlo simulation can calculate non-normal distribution accurately by random sampling and VaR model can mark the boundary between normal days and extreme events. However, they do have drawbacks. For instance, Monte Carlo simulation consumes lots of time and cost, and VaR model is undesired to deal with tails of probability distribution.

Furthermore, the criterion of a financial asset performance varies from time to time, and return of investment (ROI) is not the only criterion considered anymore. That is, performance of a financial asset having the same return of investment (ROI) in a bull market is not consistent with that in a bear market. Moreover, there is lack of useful tool on the market for investors to allocate market exposure.

The present invention provides an effective system and method to help investors analyze a financial asset by quantitative method, e.g., stability of growth, extent of fluctuations, or extent of adaptability.

### SUMMARY OF THE INVENTION

The investment allocation system for managing investment return and risk comprises a storage unit, a maximal draw-down computation unit, an operation unit, and an allocation process unit. The storage unit stores a threshold, some first data sets comprising market-to-market values of several potential investments, and the storage unit also stores some second data sets comprising market-to-market values of benchmark assets. Then the maximal draw-down computation unit transforms the first data sets into a first maximal draw-down sequence containing a first ordered list of objects and also transforms the second data sets into a second maximal draw-down sequences containing a second ordered list of objects.

Besides, the threshold is assigned to a cumulative distribution function in accordance with said first maximal draw-down sequence in order to obtain a corresponding kth-quantile thereof. Further, an operation unit inserts a specific object in accordance with the kth-quantile into the first maximal draw-down sequence. In the second maximal draw-down sequence, the operation unit further divides the number of the second list of objects having smaller values than the specific object by the number of the whole second list of objects to obtain a consistency index. Also, an allocation process unit allocates assets by processing the consistency indexes of certain potential investments.

On the other hand, the present invention provides a method of managing investment return and risk by an investment allocation system. In the beginning, the storing unit stores a threshold, some first data sets comprising market-to-market values of some potential investments, and some second data sets comprising market-to-market values of benchmark assets. Next, a maximal draw-down computation unit processes the first data set and the second data set to obtain a first maximal draw-down sequence containing a first ordered list of objects and a second maximal draw-down sequence containing a second ordered list of objects respectively.

After that, an operation unit generates a cumulative distribution function according to the first maximal draw-down sequence and assigns the threshold to the cumulative distribution function to obtain a quantile of the cumulative distribution function according to the threshold. Next, the operation unit assigns a specific object in the first ordered list of objects according to the quantile and locates the specific object in the second maximal draw-down sequence. Thus, consistency indexes can be obtained by dividing the number of the second list of objects having smaller values than the specific object by the number of the whole second list of objects. Finally, an allocation process unit allocates market exposure according to the consistency indexes.

Furthermore, the present invention discloses a computer-readable storage medium encoded with processing instructions executable by a computer for implementing a method for generating a consistency index to manage investment return and risk. The processing instructions are described as following statements. In the beginning, the storing unit stores a threshold, some first data sets comprising market-to-market values of some potential investments, and some second data sets comprising market-to-market values of benchmark assets. Next, a maximal draw-down computation unit processes the first data set and the second data set to obtain a first maximal draw-down sequence containing a first ordered list of objects and a second maximal draw-down sequence containing a second ordered list of objects respectively.

After that, an operation unit generates a cumulative distribution function according to the first maximal draw-down sequence and assigns the threshold to the cumulative distribution function to obtain a quantile of the cumulative distribution function according to the threshold. Next, the operation unit assigns a specific object in the first ordered list of objects according to the quantile and locates the specific object in the second maximal draw-down sequence. Thus, consistency indexes can be obtained by dividing the number of the second list of objects having smaller values than the specific object by the number of the whole second list of objects. Finally, an allocation process unit allocates market exposure according to the consistency indexes.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block chart of an investment allocation system of the present invention;

FIG. 2 is a schematic view showing an operation interface for the investment allocation system of the present invention;

FIG. 3 is a flow chart showing a method of an investment allocation of the present invention; and

FIG. 4 is a schematic view showing a computer-readable storage medium encoded with processing instructions executable by a computer of the present invention.

### DETAILED DESCRIPTION

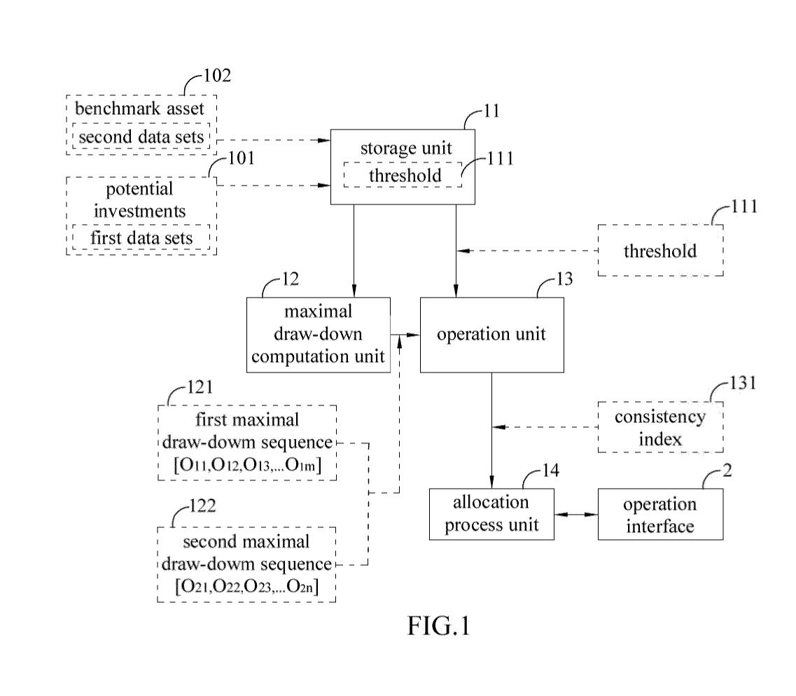

The present invention discloses an investment allocation system 1 for managing investment return and risk and method thereof. Please refer to FIG. 1, the present invention provides an investment allocation system 1 comprises a storage unit 11, a maximal draw-down computation unit 12, an operation unit 13, and an allocation process unit 14. The investment allocation system 1 can be installed in electronic devices, such as computer, PDA, or other electronic device. Also, the storage unit 11, the maximal draw-down computation unit 12, the operation unit 13, and the allocation process unit 14 can be installed in the memory or hard disk of the electronic.

The storage unit 11 stores a threshold 111, a plurality of first data sets 101 comprising market-to-market values of several potential investments, and a plurality of second data sets 102 comprising market-to-market values of benchmark assets. The benchmark assets can be historical data of some financial assets, such as historical data of finds, stocks, securities, futures, foreign currencies, bonds, options, or subscription certificates. Moreover, the benchmark assets can be a raw data provided by the user of the investment allocation system 1.

Besides, the maximal draw-down computation unit 12 transforms the plurality of first data sets 101 into a first maximal draw-down sequence 121 containing a first ordered list of objects [O₁₁, O₁₂, O₁₃, . . . , O₁ₘ] and also transforms the second data sets into a second maximal draw-down sequences 122 containing a second ordered list of objects [O₂₁, O₂₂, O₂₃, . . . , O₂ₙ]. The maximal draw-down computation calculates the maximum loss of investments from a market peak to a market nadir during certain time period.

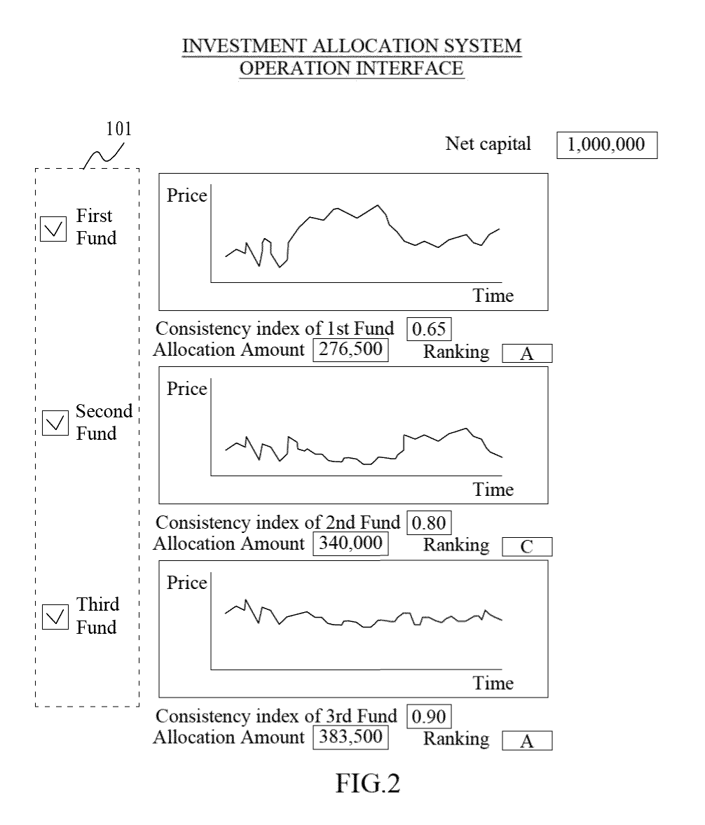

An operation unit 13 assigns the threshold to a cumulative distribution function in accordance with the first maximal draw-down sequence 121 in order to obtain a corresponding kth-quantile thereof. Further, the operation unit 13 locates a specific object in the first list of objects in accordance with the kth-quantile, and divides the number of the second list of objects having smaller values than the specific object by the number of the whole second list of objects to obtain a consistency index 131. Also referring to FIG. 2, the user of the investment allocation system 1 can choose certain potential assets 102 according to the consistency index 131 thereof through an interface 2 in. An allocation process unit 14 allocates market exposure by processing the consistency indexes 131 of the chosen assets.

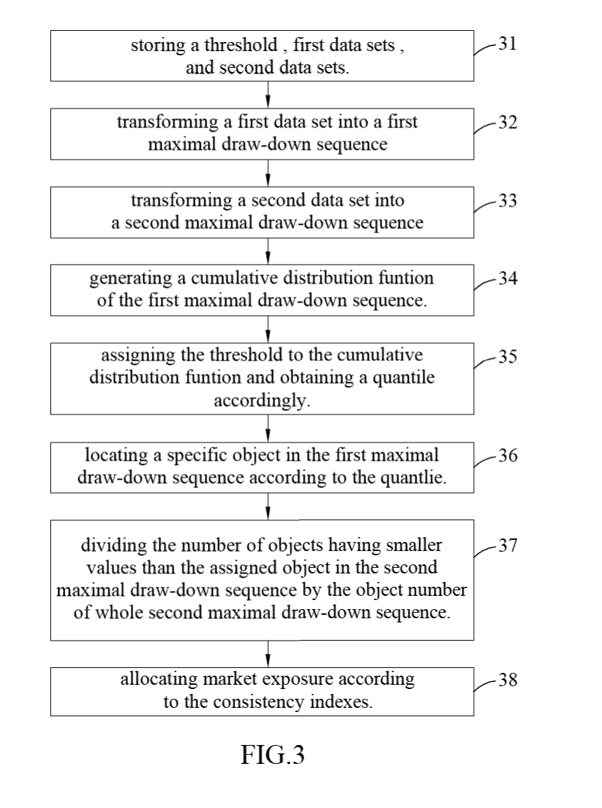

Please referring to FIG. 3, a method of investment allocation for managing investment return and risk comprising the following steps. In step 31, the storing unit stores a threshold, some first data sets comprising market-to-market values of some potential investments, and some second data sets comprising market-to-market values of benchmark assets. Next in step 32 and step 33, a maximal draw-down computation unit processes the first data set and the second data set to obtain a first maximal draw-down sequence containing a first ordered list of objects and a second maximal draw-down sequence containing a second ordered list of objects respectively.

For example, the second data set is the market-to-market values of a benchmark asset during a time period, so it would be [V₂₁, V₂₂, V₂₃, V₂₄, . . . , V₂ₙ]. Then the maximal draw-down unit processes it by the function: MDDn+h=(Vmax−V2n)/h; Vmax is the maximum value during time period h; n≧0; h is time period, which is a constant; Therefore a sequence is form and then rearrange in order it to obtain a second maximal draw-down sequence containing ordered objects, such as [O₂₁, O₂₂, O₂₃, O₂₄, . . . O₂ₙ]. By the same computation, a first maximal draw-down sequence can be also obtained, such as [O₁₁, O₁₂, O₁₃, O₁₄, . . . O₁ₘ].

Following in step 34, an operation unit generates a cumulative distribution function according to the first maximal draw-down sequence and in step 35 it assigns the threshold to the cumulative distribution function to obtain a quantile of said cumulative distribution function according to the threshold. For instance, if the threshold is a percentage 75%, the quantile according to it is 3^{rd}-quartile.

Next in step 36, the operation unit locates a specific object in the first ordered list of objects according to the quantile. Thus in step 37, consistency indexes can be obtained by dividing the number of the second list of objects having smaller values than the assigned object in step 36 by the number of the whole second list of objects. For example, if the quantile is a 3^{rd}-quartile and the object corresponding to the 3^{rd}-quartile in the first list of objects is O₁₉, the objects of the second list of objects having smaller values than O₁₉ are O₂₁, O₂₂, O₂₃, O₂₄, and the number of the whole second list of objects is n. Therefore, a consistency index of the first data set can be obtained as 4/n.

Finally in step 38, an allocation process unit allocates market exposure according to the consistency indexes. Please also referring to FIG. 2, which illustrates an operation interface and assuming if a user of the investment allocation system has net capital $1,000,000 and obtains the information that a consistency index of a first fund is 0.65, a consistency index of a second fund is 0.80, and a consistency index of a third fund is 0.90, and the user decides to invest in all three funds, the market exposure would be 27.65% for the first fund, 34% for the second fund, and 38.35% for the third fund. Those ratio are obtained by the following normalization process.

0.2765=0.65/(0.65+0.80+0.9)

0.34=0.8/(0.65+0.80+0.9)

0.3835=0.9/(0.65+0.80+0.9)

Accordingly, the user invests $276,500 in the first fund, $340,000 in the second fund, and $383,500 in the third fund.

However, users of the investment allocation system might only interest in certain types of investments or only interest in high potential investments in certain categories of investments. It would be easier for the user to choose the desire products to invest according to their rankings, so the allocation process unit may further arrange products in the same category to have different rankings, that is, A, B, C, D, and E are given to all stocks according to their consistency index, so does to all foreign currencies, to all securities, to bonds, and so on. Thus, a stock with consistency index 0.8 might be ranked as “A” in stocks category, but a foreign currencies with consistency index 0.8 might be ranked as “B” in foreign currencies category.

Therefore, assuming a user of the investment allocation system only interests in stocks and foreign currencies, also the first fund shown in FIG. 2 is a stock, and the second and the third fund are foreign currencies, since the first fund is ranked as A in the stock category and the third fund is also ranked as A in the foreign currencies category while the second fund is ranked as C in the foreign currencies category. A conservative investor who only interests in stock and foreign currencies may adjust the market exposure of these three funds to 1:0.9:1 by assigning larger coefficient to higher ranking.

0.65=0.65×1

0.72=0.8×0.9

0.9=0.9×1

Then perform normalization process to the three chosen stocks as follows to obtain the market exposure is 28.63% for the first stock, 31.32% for the second fund, and 39.65% for the third stock fund.

0.2863=0.65/(0.65+0.72+0.9)

0.3132=0.72/(0.65+0.72+0.9)

0.3965=0.9/(0.65+0.72+0.9)

Accordingly, the user invests $286,300 in the first stock, $313,200 in the second fund, and $396,500 in the third fund.

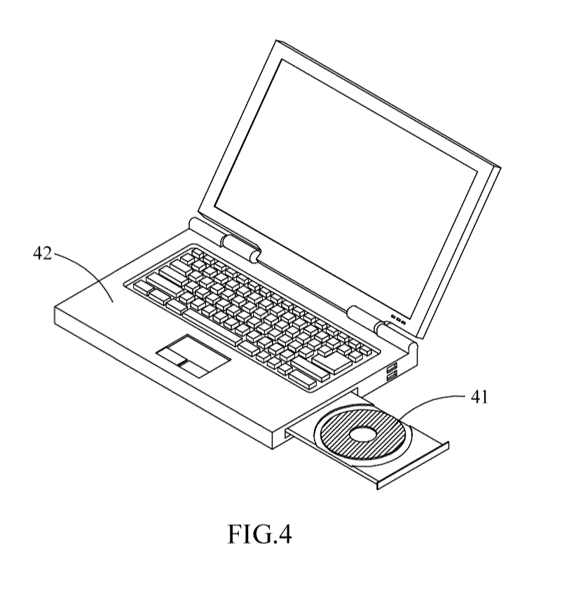

Now please refer to FIG. 4, the present invention also discloses a computer-readable storage medium 41 encoded with processing instructions executable by a computer 42 for implementing a method for generating a consistency index to manage investment return and risk. Please also refer to FIG. 3, the processing instructions executed in the computer 42 are illustrated as following. The computer-readable storage medium 41 may be a CD, flash disk, floppy disk, or a removable hard disk.

In step 31, the storing unit stores a threshold, some first data sets comprising market-to-market values of some potential investments, and some second data sets comprising market-to-market values of benchmark assets. Next in step 32 and step 33, a maximal draw-down computation unit processes the first data set and the second data set to obtain a first maximal draw-down sequence containing a first ordered list of objects and a second maximal draw-down sequence containing a second ordered list of objects respectively.

For example, the second data set is the market-to-market values of a benchmark asset during a time period, so it would be [V₂₁, V₂₂, V₂₃, V₂₄, . . . , V₂ₙ]. Then the maximal draw-down unit processes it by the function: MDDn+h=(Vmax−V2n)/h; Vmax is the maximum value during time period h; n≧0; h is time period, which is a constant; Therefore a sequence is form and then rearrange in order it to obtain a second maximal draw-down sequence containing ordered objects, such as [O₂₁, O₂₂, O₂₃, O₂₄, . . . O₂ₙ]. By the same computation, a first maximal draw-down sequence can be also obtained, such as [O₁₁, O₁₂, O₁₃, O₁₄, . . . O₁ₘ].

Following in step 34, an operation unit generates a cumulative distribution function according to the first maximal draw-down sequence and in step 35 it assigns the threshold to the cumulative distribution function to obtain a quantile of said cumulative distribution function according to the threshold. For instance, if the threshold is a percentage 75%, the quantile according to it is 3^{rd}-quartile.

Next in step 36, the operation unit locates a specific object in the first ordered list of objects according to the quantile. Thus in step 37, consistency indexes can be obtained by dividing the number of the second list of objects having smaller values than the assigned object in step 36 by the number of the whole second list of objects. For example, if the quantile is a 3^{rd}-quartile and the object corresponding to the 3^{rd}-quartile in the first list of objects is O₁₉, the objects of the second list of objects having smaller values than O₁₉ are O₂₁, O₂₂, O₂₃, O₂₄, and the number of the whole second list of objects is n. Therefore, a consistency index of the first data set can be obtained as 4/n.

Finally in step 38, an allocation process unit allocates market exposure according to the consistency indexes. Please also referring to FIG. 2, FIG. 2 illustrates an operation interface and assuming if a user of the investment allocation system has net capital $1,000,000 and obtains the information that a consistency index of a first fund is 0.65, a consistency index of a second fund is 0.80, and a consistency index of a third fund is 0.90, and the user decides to invest in all three funds, the market exposure would be 27.65% for the first fund, 34% for the second fund, and 38.35% for the third fund. Those ratio are obtained by the following normalization process.

0.2765=0.65/(0.65+0.80+0.9)

0.34=0.8/(0.65+0.80+0.9)

0.3835=0.9/(0.65+0.80+0.9)

Accordingly, the user invests $276,500 in the first fund, $340,000 in the second fund, and $383,500 in the third fund.

However, users of the investment allocation system might only interest in certain types of investments or only interest in high potential investments in certain categories of investments. It would be easier for the user to choose the desire products to invest according to their rankings, so the allocation process unit may further arrange products in the same category to have different rankings, that is, A, B, C, D, and E are given to all stocks according to their consistency index, so does to all foreign currencies, to all securities, to bonds, and so on. Thus, a stock with consistency index 0.8 might be ranked as “A” in stocks category, but a foreign currencies with consistency index 0.8 might be ranked as “B” in foreign currencies category.

Therefore, assuming a user of the investment allocation system only interests in stocks and foreign currencies, also the first fund shown in FIG. 2 is a stock, and the second and the third fund are foreign currencies, since the first fund is ranked as A in the stock category and the third fund is also ranked as A in the foreign currencies category while the second fund is racked as C in the foreign currencies category. A conservative investor who only interests in stock and foreign currencies may adjust the market exposure of these three funds to 1:0.9:1 by assigning larger coefficient to higher ranking.

0.65=0.65×1

0.72=0.8×0.9

0.9=0.9×1

Then perform normalization process to the three chosen stocks as follows to obtain the market exposure is 28.63% for the first stock, 31.32% for the second fluid, and 39.65% for the third stock fund.

0.2863=0.65/(0.65+0.72+0.9)

0.3132=0.72/(0.65+0.72+0.9)

0.3965=0.9/(0.65+0.72+0.9)

Accordingly, the user invests $286,300 in the first stock, $313,200 in the second fund, and $396,500 in the third fund.

The present invention has been described with some preferred embodiments thereof and it is understood these embodiments are illustrated only for exemplification and not intended to limit the present invention. The control of the light-emitting units to different brightness or the adjustment of the display parameters can be performed independently or at the same time. It is also understood that many changes and modifications in the described embodiments can be carried out without departing from the scope and the spirit of the invention that is intended to be limited only by the appended claims.

What is claimed is:

1. An investment allocation system for managing investment return and risk comprising:
a storage unit tangibly embodied in a device and storing a plurality of first data sets each comprising market-to-market values of one of a plurality of potential investments, and said storage unit further storing a second data set comprising market-to-market values of a benchmark asset;
a maximal draw-down computation unit tangibly embodied in said device and transforming said first data set into a first maximal draw-down sequence containing a first ordered list of objects, and transforming each of said second data sets into a second maximal draw-down sequences containing a second ordered list of objects; a threshold stored in said storage unit and assigned to a cumulative distribution function in accordance with said first maximal draw-down sequence in order to obtain a corresponding kth-quantile thereof;
an operation unit tangibly embodied in said device and locating a specific object in said first ordered list of objects in accordance with said kth-quantile; in said second maximal draw-down sequence, said operation unit further dividing the number of said second list of objects having smaller values than said specific object by the number of the whole second list of objects to obtain a consistency index; and
an allocation process unit tangibly embodied in said device for allocating assets by processing consistency indexes of a plurality of potential investments.

2. The investment allocation system in claim 1, said storage unit, said maximal draw-down computation unit, said operation unit, and said allocation process unit are tangibly embodied in said device, wherein said device selected from a memory and a hard disk.

3. The investment allocation system in claim 1, wherein said benchmark asset are selected from historical data of at least one financial asset and raw data provided by the user of said investment allocation system.

4. The investment allocation system in claim 2, wherein said financial asset is selected from funds, stocks, securities, futures, foreign currencies, bonds, options, and subscription certificates.

5. The investment allocation system in claim 1, wherein said maximal draw-down sequences are obtained by the following function: MDDn+h=(Vmax−Vn)/h, MDD is the maximal draw-down sequence containing ordered objects; Vn are market-to-market values from said first data set and second data set and h is time period, which is a constant; and Vmax is the maximum value during each time period h.

6. The investment allocation system in claim 1, wherein said threshold is a pre-determined possibility of a cumulative distribution function generated in accordance with said first maximal draw-down sequence and said first maximal draw-down sequence is divided into certain quantiles.

7. The investment allocation system in claim 1, wherein said allocation process unit processes a normalization on said consistency indexes of several financial assets and allocates market exposure accordingly.

8. A method of investment allocation for managing investment return and risk comprising the following steps:
storing a threshold in a storage unit tangibly embodied in a device;
storing a plurality of first data sets each comprising market-to-market values of one of a plurality of potential investments in a storage unit tangibly embodied in said device;
selecting second data set comprising market-to-market values of a benchmark asset in said storage unit tangibly embodied in said device;
processing said first data set by a maximal draw-down computation unit tangibly embodied in said device and then obtaining a first maximal draw-down sequence containing a first ordered list of objects;
processing said second data set by said maximal draw-down computation unit tangibly embodied in said device and then obtaining a second maximal draw-down sequence containing a second ordered list of objects;
generating a cumulative distribution function according to said first maximal draw-down sequence by an operation unit tangibly embodied in said device;
assigning said threshold to said cumulative distribution function by said operation unit;
choosing a quantile of said cumulative distribution function according to said threshold by said operation unit;
locating a specific object in said first ordered list of objects according to said quantile by said operation unit;
obtaining a consistency indexes in said operation unit by dividing the number of said second list of objects having smaller values than said specific object by the number of the whole second list of objects; and
allocating market exposure according to said consistency indexes by an allocation process unit tangibly embodied in said device.

9. The method of investment allocation for managing investment return and risk in claim 8, wherein said storage unit, said maximal draw-down computation unit, said operation unit, and said allocation process unit are tangibly embodied in said device, wherein said device selected from a memory and a hard disk.

10. The method of investment allocation for managing investment return and risk in claim 8, wherein said benchmark asset are selected from historical data of at least one financial asset and raw data provided by the user of said investment allocation system.

11. The method of investment allocation for managing investment return and risk in claim 10, wherein said financial asset is selected from funds, stocks, securities, futures, foreign currencies, bonds, options, and subscription certificates.

12. The method of investment allocation for managing investment return and risk in claim 8, wherein said steps of processing said first and second data set in said maximal draw-down computation unit to obtain said first and second maximal draw-down sequences comprise the following computation: MDDn+h=(Vmax−Vn)/h, MDD is the maximal draw-down sequence containing ordered objects; Vn are market-to-market values from the second data set and n≧0; h is time period, which is a constant; and Vmax is the maximum value during each time period h.

13. The method of investment allocation for managing investment return and risk in claim 8, wherein the step of allocating market exposure according to said consistency index further comprises the steps of:
performing a normalization process on said consistency indexes of a plurality of financial assets; and
allocating market exposure by the result of said normalization process.

14. A computer-readable storage medium encoded with processing instructions executable by a computer for implementing a method for generating a consistency index to manage investment return and risk, wherein said processing instructions, when executed in said computer, comprising:
storing a threshold in a storage unit tangibly embodied in a device;
storing a plurality of first data sets each comprising market-to-market values of one of a plurality of potential investments in a storage unit tangibly embodied in said device;
selecting second data set comprising market-to-market values of a benchmark asset in said storage unit tangibly embodied in said device;
processing said first data set by a maximal draw-down computation unit tangibly embodied in said device and then obtaining a first maximal draw-down sequence containing a first ordered list of objects;
processing said second data set by said maximal draw-down computation unit tangibly embodied in said device and then obtaining a second maximal draw-down sequence containing a second ordered list of objects;
generating a cumulative distribution function according to said first maximal draw-down sequence by an operation unit tangibly embodied in said device;
assigning said threshold to said cumulative distribution function by said operation unit;
choosing a quantile of said cumulative distribution function according to said threshold by said operation unit;
locating a specific object in said first ordered list of objects according to said quantile by said operation unit;
obtaining a consistency indexes in said operation unit by dividing the number of said second list of objects having smaller values than said specific object by the number of the whole second list of objects; and
allocating market exposure according to said consistency indexes by an allocation process unit tangibly embodied in said device.

15. The computer-readable storage medium in claim 14, wherein said storage unit, said maximal draw-down computation unit, said operation unit, and said allocation process unit are tangibly embodied in said device, wherein said device selected from a memory and a hard disk.

16. The computer-readable storage medium in claim 14, wherein said benchmark asset are selected from historical data of at least one financial asset and raw data provided by the user of said investment allocation system.

17. The computer-readable storage medium in claim 16, wherein said financial asset is selected from funds, stocks, securities, futures, foreign currencies, bonds, options, and subscription certificates.

18. The computer-readable storage medium in claim 14, wherein said instructions of processing said first and second data set in said maximal draw-down computation unit to obtain said first and second maximal draw-down sequences comprise the following computation: MDDn+h=(Vmax-Vn)/h, MDD is the maximal draw-down sequence containing ordered objects; Vn are market-to-market values from said first data set and second data set and n≧0; h is time period, which is a constant; and Vmax is the maximum value during each time period h.

19. The computer-readable storage medium in claim 14, wherein said instructions of allocating market exposure according to said consistency index further comprises the instructions of
performing a normalization process on said consistency indexes of a plurality of financial assets; and
allocating market exposure by the result of said normalization process.
